(19) United States
(12) Patent Application Publication
(10) Pub. No.: US 2016/0210798 A1
(43) Pub. Date: Jul. 21, 2016

(54) INDUCTIVE BINARY CODED LOCK MECANISM

(71) Applicant: TEXAS INSTRUMENTS INCORPORATED, Dallas, TX (US)

(72) Inventor: George Pieter Reitsma, Redwood City, CA (US)

(21) Appl. No.: 15/003,790

(22) Filed: Jan. 21, 2016

Related U.S. Application Data
(60) Provisional application No. 62/106,143, filed on Jan. 21, 2015.

(51) Int. Cl. G07C 9/00; E05B 47/00

(52) U.S. Cl. CPC G07C 9/00007; E05B 47/00

(57) ABSTRACT

An inductive coded lock system includes an inductive lock mechanism, and a conductive key/target. The inductive lock mechanism includes multiple inductor coils and sensor circuitry. Each inductor coil is operable to project a magnetic field defining a sensing area proximate to the inductor/coil, the inductor coils being spatially arranged to define a key/target sensing area incorporating each inductor coil sensing area. The sensor circuitry drives inductor coils, and measures sensor response (such as with an inductance comparator) to a key/target inserted within the key/target sensing area, including detecting an unlock condition corresponding to a pre-defined coded lock pattern. The key/target includes active and inactive areas (such as conductive/nonconductive) corresponding spatially to the sensing areas in the key target sensing area, the active and inactive areas arranged in a pre-defined coded key pattern corresponding to the pre-defined coded lock pattern. The coded lock and key patterns can be binary coded.

### CROSS-REFERENCE TO RELATED APPLICATIONS

Priority is claimed under 37 CFR 1.78 and 35 USC 119(e) to U.S. Provisional Application 62/106143 (Docket TI-75778PS), filed 21-Jan.-2015, which is incorporated by reference.

### BACKGROUND

Technical Field. This Patent Disclosure relates generally to inductive proximity sensors/switches.

Related Art. An inductive sensor includes an inductive coil sensor and sensor electronics. The sensor electronics drives the sensor coil, projecting a sensing B-Field, and then measures/acquires a sensor response, such as a change in sensor coil inductance in response to a conductive target.

As illustrated in FIG. 1, for proximity sensing, an inductive proximity sensor/switch with a sensor coil (11) is designed to switch when a conductive target (13) is proximate to the sensor coil (within the sensor coil's sensing range). An inductive sensor (coil and electronics) can be configured for sensitivity to a conductive target that is present immediately proximate to the coil, within a sensing area (15).

### BRIEF SUMMARY

This Brief Summary is provided as a general introduction to the Disclosure provided by the Detailed Description and Drawings, summarizing aspects and features of the Disclosure. It is not a complete overview of the Disclosure, and should not be interpreted as identifying key elements or features of, or otherwise characterizing or delimiting the scope of, the disclosed invention.

According to aspects of the Disclosure, an inductive coded lock system includes an inductive lock mechanism, and a conductive key/target. The inductive lock mechanism includes multiple inductor coils and sensor circuitry. Each inductor coil is operable to project a magnetic field defining a sensing area proximate to the inductor/coil, the inductor coils are spatially arranged to define a key/target sensing area incorporating each inductor coil sensing area. The sensor circuitry drives the inductor coils, and measures sensor response to a key/target inserted within the key/target sensing area, including detecting an unlock condition corresponding to a pre-defined coded lock pattern. The key/target configured with active and inactive areas (such as conductive and nonconductive) corresponding spatially to the sensing areas in the key target sensing area, the active and inactive areas arranged in a pre-defined coded key pattern corresponding to the pre-defined coded lock pattern. The coded lock pattern and coded key pattern can be binary coded. The sensor circuitry can include a differential inductance comparator coupled to the inductor coils.

Other aspects and features of the invention claimed in this Patent Document will be apparent to those skilled in the art from the following Disclosure.

### BRIEF DESCRIPTION OF THE DRAWINGS

FIG. 1 illustrates a inductive sensing, including an inductive sensing coil operable to generate a sensing field defining a sensing area.

FIG. 2 illustrates an example functional embodiment of an inductive binary coded security system (200), including an inductive binary coded lock mechanism (210) configured for operation with a binary coded conductive key/target (215), the lock mechanism (210) including multiple inductor coils (211) coupled to sensor electronics (213).

FIG. 3 illustrates an example functional embodiment of an inductive lock mechanism (310), in which the sensor electronics is implemented with a differential inductance comparator (313) with L+ and L− differential inputs coupled to the inductor coils, and with an inductance offset (Loffset).

FIGS. 4A/4B illustrates an example functional embodiment of an inductive binary coded lock mechanism (410) using a differential inductance comparator (413) with L+ and L− differential inputs, and including an internal sensor lock/target (414) that defines a binary coded sensor lock pattern: FIG. 4A illustrates a functional embodiment with two rows of inductor coils, requiring correspondingly configured key/target (415) and sensor lock/target (414); and FIG. 4B is a simplified functional illustration.

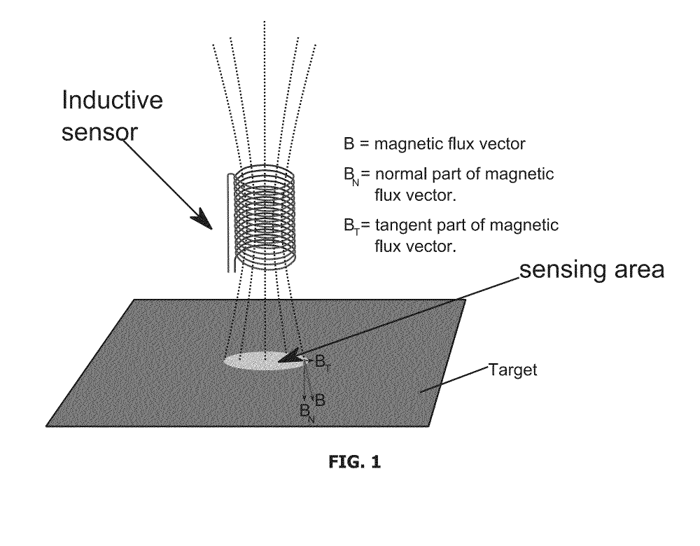

### DETAILED DESCRIPTION

This Description and the Drawings constitute a Disclosure for ground fault detection based on capacitive sensing, including example embodiments that illustrate various technical features and advantages.

In brief overview, an inductive coded lock system includes an inductive lock mechanism, and a conductive key/target. The inductive lock mechanism includes multiple inductor coils and sensor circuitry. Each inductor coil is operable to project a magnetic field defining a sensing area proximate to the inductor/coil, the inductor coils being spatially arranged to define a key/target sensing area incorporating each inductor coil sensing area. The sensor circuitry drives inductor coils, and measures sensor response (such as with an inductance comparator) to a key/target inserted within the key/target sensing area, including detecting an unlock condition corresponding to a pre-defined coded lock pattern. The key/target includes active and inactive areas (such as conductive/nonconductive) corresponding spatially to the sensing areas in the key target sensing area, the active and inactive areas arranged in a pre-defined coded key pattern corresponding to the pre-defined coded lock pattern. The coded lock and key patterns can be binary coded.

Lock mechanism is used in this Disclosure as a general, non-limiting term for a mechanism that provides a point of secure entry or access requiring an associated physical key or unlocking device.

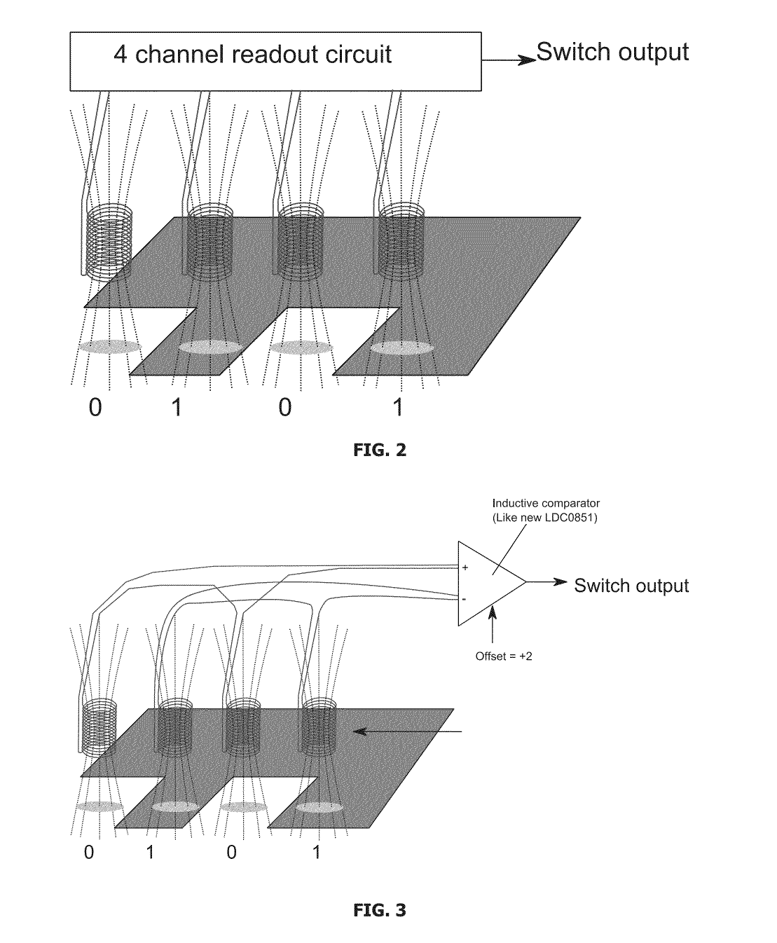

FIG. 2 illustrates an example functional embodiment of an inductive binary coded security system 200, including an inductive binary coded lock mechanism 210 configured for operation with a binary coded conductive key/target 215. Lock mechanism 210 includes multiple inductor coils 211 coupled to sensor electronics 213.

Inductor coils 211 are spatially arranged to define a key/target sensing area 212 into which key/target 215 can be introduced/inserted, proximate to the inductor coils. As illustrated, inductor coils 211_1 to 211_N each define an associated sensing areas 212_1 to 212_N within key/target sensing area 212.

Key/target 215 is constructed of metallic or other conductive or magnetic material (the terms conductive/nonconductive and metallic /nonmetallic are used interchangeably in this Disclosure). Since an inductive coil does not respond to any target that is both non-magnetic and non-conductive, the key/target can be encapsulated in a non-magnetic/non-conductive enclosure, for example, plastic.

According to this Disclosure, inductive lock mechanism 210 is configured for use with a conductive key/target 215 constructed with a pre-defined coded pattern of metallic and non-metallic areas designated 215_1 to 215_N. According to aspects of this Disclosure, inductive lock mechanism 210 and key/target 215 are configured for a pre-defined binary coded lock/key pattern, in which lock mechanism 210 embodies a binary coded lock pattern, and key/target 215 embodies a corresponding binary coded key pattern.

That is, inductive lock mechanism 210 (sensor electronics 213) is configured (programmed) to respond only to a proximate key/target (within key/target sensing area 212) with the pre-defined binary coded sequence or key pattern of metallic/nonmetallic areas: 1 metal, 0=nonmetallic. In effect, lock mechanism 210 defines sensing areas 212_1-N (within key/target sensing area 212) as a binary coded lock pattern corresponding to the binary coded key pattern of metallic/nonmetallic areas 215_1-N of key/target 215. Sense coils 211_1-N associated with metallic areas of the binary coded key pattern are referred to as active coils, and sense coils 211_1-N associated with nonmetallic areas of the binary coded key pattern are referred to as inactive coils.

Sensor electronics 213 is configured to drive inductor coils 211, and to measure sensor response. Sensor electronics 213 includes sensor readout circuitry that acquires sensor response measurements (such as inductor coil inductance) representative of target proximity and, according to this Disclosure, target construction. For example, the inductive lock mechanism 210 can be configured for resonant inductive sensing, including sensor resonators (such as an LC tank circuits), and sensor electronics designed to drive sensor resonators, and acquire sensor response measurements from the sensor resonators.

As illustrated in FIG. 2, the binary coded sequence or lock/key pattern is 0101, and sensor electronics 213 is configured to switch/activate only for that code, detected as an unlock condition. That is, as illustrated in FIG. 2, inductive sensor lock mechanism 210 will switch/activate to detect an unlock condition only if key/target 215 is configured with a binary coded metal key pattern such that, when inserted proximate to inductive lock mechanism 210 (within key/target sensing area 214), key/target metal is present within the sensing areas of only inductor/coils 2 and 4 (i.e., the active coils). Any other key pattern (code) will not trigger/activate the lock mechanism (i.e., sensor electronics 213 will not detect an unlock condition).

The functional embodiment of lock mechanism 210 illustrated in FIG. 2 requires four sensor/readout circuits, or a single sensor readout circuit with a multiplexing scheme. If multiple sensor/readout circuits are use, the number increases with the number of bits used for the encoding.

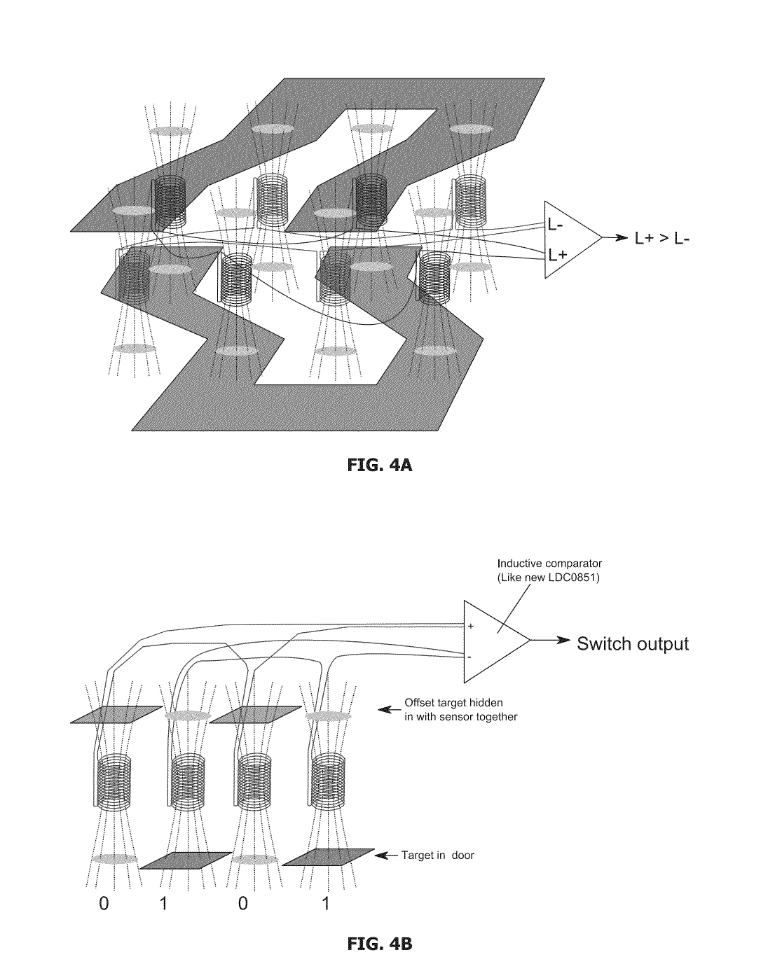

FIGS. 3 and 4A/4B illustrate example functional embodiments of an inductive binary coded lock mechanism, including inductor coils series connected to sensor electronics comprising a differential inductance comparator.

FIG. 3 illustrates an example functional embodiment of an inductive lock mechanism 310, in which sensor electronics comprises a differential inductance comparator 313. Inductance comparator 313 is configured for operation with an inductance offset (Loffset).

Sense coils 311_1-N are series connected to the L+ and L− inputs to inductance comparator 313 according to the binary coded lock/key pattern. Specifically, the active coils (illustrated as inductor coils 2 and 4) are series connected to L+, and the inactive coils (illustrated as inductor coils 1 and 3) are series connected to L−). Loffset corresponds to the difference in inductance due to the number of active coils connected to the L+ input of the comparator (minus one), and the number of inactive coils connected to the L− input, so that (L+)+(Loffset)>L−.

To trip inductance comparator 313, the binary coded target key pattern 315_1-N must match the binary-coded sensor lock pattern 312_1-N, as reflected in Loffset. That is, inductance comparator 313 measures the difference between two inductances, and activates (trips) if one is higher than the other (counteracting Loffset).

FIGS. 4A/4B illustrates an example functional embodiment of an inductive binary coded lock mechanism 410 using a differential inductance comparator 413 (with L+ and L− inputs), and including an internal sensor lock/target 414. As elaborated below, sensor lock/target 414 defines a binary coded sensor lock pattern. This example embodiment takes advantage of the fact that both sides of an inductor coil have equal sensitivity.

FIG. 4A illustrates a functional embodiment with two rows of inductor coils, requiring correspondingly configured key/target 415 and sensor lock/target 414. FIG. 4B is a simplified functional illustration.

For this embodiment, half of inductor coils 411_1-N are series connected to the L+ input, and the other half of inductor coils 411_1-N are connected to the L− input, without regard to whether a particular inductor coil is active or inactive (i.e., whether it will sense a metallic or nonmetallic area of key/target 415.

Sensor lock/target 414 defines a binary coded sensor lock pattern based on metallic/nonmetallic areas, effectively creating an inductance offset. The binary coded key pattern of key/target 415 is configured as complementary to the sensor lock pattern established by sensor lock/target 414 (in terms of active/inactive inductor coils). To trip (switch) inductance comparator 413, the metallic areas of the complementary key pattern of key/target 415 must be aligned with the inactive inductor coils, as defined dark red inductor/coils, counteracting the Loffset established by the sensor lock pattern of sensor lock/target 414.

Matching requirements for the distances between inductor coils 411 and sensor lock/target 414 and a proximate key/target 415 are not critical. However, to ensure trip/switching when key/target 415 is inserted proximate to lock mechanism 410 (inductor coils 411), the lock mechanism can be configured so that the proximate key/target is closer to the inductor coils than the internal sensor lock/target. For example, assume that the largest inductance change for one of the inactive inductor coils due to the presence a metallic area of target/lock 415 is delta_L, and that the difference in distance from inductor coils 411 to sensor lock/target 414 and to key/target 415 is delta_D. Ideally the sensor lock/target and the key/target cause identical inductance changes in the two chains of series connected inductor coils (identical distances to the inductor coils). However, to ensure trip/switching, key/target 415 can be placed closer to inductor coils 411 by a distance delta_D so long as the total inductance reduction in the chain due delta_D is less than delta_L.

Advantages of this embodiment of the inductive lock mechanism include: (a) extension to an arbitrary number of bits, without requiring more inductance comparators, and (b) an equal number of identical inductor coils connected to the L+ and L− inputs of the inductance comparator.

For all embodiments, rather than having the binary 1 and 0 represented by a metal and nonmetal, the binary 1 and 0 can be represented by target metal at different distances relative to the inductor coils. For example, a zero can be represented by a conductive target at a larger distance, so that a 1 is represented by a bump on the key/target.

Advantages of the inductive binary coded inductive locking mechanism include allowing for many different keys, such that each lock can be given a unique key, and providing a security/sensor that cannot be defeated by the introduction of an external magnet (such as in reed switch security implementations. Also, the inductive binary coded sensor/switch is adaptable to configurations with a single differential inductance comparator, reducing system cost.

In summary, an inductive coded lock system includes an inductive lock mechanism, and a conductive key/target. The inductive lock mechanism includes multiple inductor coils and sensor circuitry. Each inductor coil is operable to project a magnetic field defining a sensing area proximate to the inductor/coil, the inductor coils are spatially arranged to define a key/target sensing area incorporating each inductor coil sensing area. The sensor circuitry drives the inductor coils, and measures sensor response to a key/target inserted within the key/target sensing area, including detecting an unlock condition corresponding to a pre-defined coded lock pattern. The key/target configured with active and inactive areas (such as conductive and nonconductive) corresponding spatially to the sensing areas in the key target sensing area, the active and inactive areas arranged in a pre-defined coded key pattern corresponding to the pre-defined coded lock pattern. The coded lock pattern and coded key pattern can be binary coded. The sensor circuitry can include a differential inductance comparator coupled to the inductor coils.

The Disclosure provided by this Description and the Figures sets forth example embodiments and applications illustrating aspects and features of the invention, and does not limit the scope of the invention, which is defined by the claims. Known circuits, functions and operations are not described in detail to avoid obscuring the principles and features of the invention. These example embodiments and applications can be used by ordinarily skilled artisans as a basis for modifications, substitutions and alternatives to construct other embodiments, including adaptations for other applications.

1. A system, comprising an inductive lock mechanism; and
a conductive key/target;
the inductive lock mechanism including
multiple inductor coils each operable to project a magnetic field defining a sensing area proximate to the inductor/coil,
the inductor coils are spatially arranged to define a key/target sensing area incorporating each inductor coil sensing area,
sensor circuitry configured to drive the inductor coils, and to measure sensor response to a key/target inserted within the key/target sensing area, including detecting an unlock condition corresponding to a pre-defined coded lock pattern;
the key/target configured with active and inactive areas corresponding spatially to the sensing areas in the key target sensing area, the active and inactive areas arranged in a pre-defined coded key pattern corresponding to the pre-defined coded lock pattern.

2. The system of claim 1, wherein the coded lock pattern and the coded key pattern are binary coded.

3. The system of claim 1:
wherein the sensor circuitry comprises a differential inductance comparator with L+ and L− inputs, the inductance comparator configured to receive an inductance offset value Loffset, and wherein
the inductor coils associated with active areas of the key/target are designated active inductor coils, and the coils associated with the inactive areas of the key/target are designated inactive inductor coils; and
the active inductor coils are series connected to the L+ input, and the inactive inductor coils are series connected to the L− input, such that a match between the coded key pattern and the coded lock pattern counteracts Loffset, and is detected as an unlock condition.

4. The system of claim 1,
wherein the inductive lock mechanism further includes a sensor lock/target disposed relative to the inductor coils opposite the key/target sensing area, and wherein
the sensor lock/target is configured with active and inactive areas that define a coded sensor lock pattern, and
the key/target is configured with active and inactive areas that define a coded key pattern that is a complement of the coded sensor lock pattern;
wherein the sensor circuitry comprises a differential inductance comparator with L+ and L− inputs; and
wherein a first set of inductor coils are series-connected to the L+ input, and a second set of inductor coils is series-connected to the L− input.

5. The system of claim 1, wherein the active and inactive areas of the key/target are determined by one of: (a) conductive/active and nonconductive/inactive material, and (b) a distance of conductive material from an inductor coil.
